(19) United States
(12) Patent Application Publication
(10) Pub. No.: US 2025/0297645 A1
(43) Pub. Date: Sep. 25, 2025

(54) BEARING COMPONENT MADE OF CAST IRON AND PROCESS FOR PRODUCTION THEREOF

(71) Applicant: AKTIEBOLAGET SKF, GOTEBORG (SE)

(72) Inventors: Padelis KATSAROS, Schweinfurt (DE); Juergen GEGNER, Forchheim (DE); Karsten ZUHL, Lüchow (DE); Dieter SCHLEYER, Üchtelhausen/Hesselbach (DE)

(21) Appl. No.: 19/081,388

(22) Filed: Mar. 17, 2025

(30) Foreign Application Priority Data
Mar. 25, 2024 (DE) 102024202848.7

(51) Int. Cl. F16C 33/62; C21D 1/26; F16C 19/02; F16C 33/64

(52) U.S. Cl. CPC F16C 33/62; C21D 1/26; F16C 19/02; F16C 33/64; F16C 2223/18

(57) ABSTRACT

A bearing component for a roller bearing includes a main body that forms the bearing component and is made of an iron-containing material having a pearlitic base structure and/or ferritic base structure. The main body has at least one raceway designed such that at least one rolling body can roll thereon. Preferably, the material of the main body includes cast iron and the at least one raceway is an inductively hardened.

### CROSS-REFERENCE

This application claims priority to German patent application no. 102024202848.7 filed on Mar. 25, 2024, the contents of which are fully incorporated herein by reference.

### BACKGROUND OF THE INVENTION

The present invention relates to bearings, and more particularly to a bearing component made of a cast iron and a process for producing such a bearing component.

In many manufacturing fields, it is desirable to make the components as lightweight as possible in order, for example, to save material, costs and/or energy. However, it may be the case that a material cannot be processed and/or configured as would ideally be necessary. For example, it is known that forged steel hubs having integrated hardened raceways on which rolling bodies can roll can be used in wheel bearings in order to enable rotation of the hub relative to an axis. However, forged hubs have the disadvantage that their shape and/or geometry is dependent on the forging method used, and the forging material cannot be optimized to the distribution of load. This leads to shapes that have too much material in regions that are not under corresponding stress, which makes the hubs unnecessarily heavy.

A further known process for producing components is casting. Casting makes it possible to more easily produce complex shapes and/or geometries. For example, it is possible to use cast iron. Cast iron has a lower density than forged steel, so the resulting product is usually lighter than a comparable product made of forged steel. However, cast iron does not have the hardness necessary for integrating raceways, for example, directly into a cast iron bearing component. For example, in order to rotatably connect a gear hub and an axle, it is generally necessary when using a cast iron gear hub to provide a bearing unit connected to the gear hub, for example, by a press fit. This has the disadvantage that the gear hub has to be designed such that it can accommodate the bearing ring with an overlap, which leads to a press seat with relatively greater wall thickness in order to withstand the additional stress induced by the press fit. This in turn has the consequence that the gear hub is relatively bulky and therefore heavy.

Furthermore, the overlap tolerances needed for a press fit in the bearing rings that have been pressed in or pressed on can lead to extreme difficulties in the adjustment of bearing preload or bearing play of the bearing unit. As is known, correct bearing play or bearing preload has a significant influence on the lifetime and friction of the bearing.

It is therefore an object of the present invention to provide a bearing component that requires less weight and/or material compared to known bearing components.

### SUMMARY OF THE INVENTION

This object is achieved by the bearing component of the present invention, which comprises a main body forming the bearing component and having at least one raceway configured for supporting at least one rolling body, the main body being made of cast iron and the at least one raceway being inductively hardened.

What follows is a proposal for a bearing component, especially for a roller bearing, wherein the bearing component has a main body that forms the bearing component. The bearing component may especially be a gear hub or a bearing ring. The main body has at least one raceway designed such that at least one rolling body can roll thereon. The at least one rolling body may be, for example, a ball, a cylinder roller, a cone roller, a pendulum roller, a needle roller or the like.

In order to achieve a component with less weight and/or material compared to known bearing components, the present bearing component is made from cast iron and has an inductively hardened raceway. By virtue of the integrated, inductively hardened raceway, it is possible to reduce a material thickness needed to provide the necessary overlap tolerances in the case of indented or inserted bearing rings, since the raceway is formed directly on the bearing component. A further advantage is that a phenomenon referred to as “creeping”, in which an indented or inserted component rotates or slips relative to the other component and which can occur in the case of a press fit does not occur in the case of the bearing ring described, since the raceway is integrated in the component.

Cast iron is an iron-carbon alloy having a high proportion of carbon (>2%). Moreover, cast iron may also comprise further elements such as silicon, manganese, chromium, nickel or the like.

What is meant by “inductive hardening” in the present disclosure, which is also referred to as inductive boundary layer hardening, is a method of surface hardening in which metallic components are only partially hardened in the outer layers. During surface hardening, new material properties can arise in the hardened regions through austenitization due to the transformation of microstructure. In the case of inductive hardening, the hardened surface may become wear-resistant and/or hard, while the ductility of the initial or base material is preserved within the interior of the component. In the case of inductive hardening, the components are exposed to an alternating magnetic field within a very short period of time. This results in heating of the component at the surface and may be heated until red hot. The extent to which the heating penetrates into the component may be especially dependent on the frequency of the magnetic field. Specifically, the higher the frequency of the magnetic field, the lesser the depth of the fully heated layer. The induction hardening may be followed by quenching, for example with water.

The cast iron is preferably a spheroidal graphite cast iron. Spheroidal graphite cast iron, which is also referred to as SG cast iron, is an iron-carbon casting material where the carbon is in the form of spheroidal graphite particles. It is also referred to as ductile cast iron. Spheroidal graphite cast iron can advantageously have steel-like mechanical properties.

In a further preferred embodiment, the bearing component is at least partly composed of austenitic-ferritic spheroidal graphite cast iron (austempered ductile iron or “ADI”). ADI is described in DIN EN 1564:2012-01. ADI can be used as an alternative to cast steel and also forged steel in components that are subject to high stress. ADI, for a spheroidal graphite cast iron, has relatively high yield points and tensile strengths coupled with simultaneously high ductility, and simultaneously offers the advantages of a cast material with regard to shaping or forming. The basis used for ADI is spheroidal graphite cast iron, which is subjected to a specific heat treatment referred to as bainitization or ausferritization. In such a heat treatment, the component is first austenitized, then quenched to a defined or specified temperature, in order to remain isothermally at that temperature for a prolonged period of time during the process. After a particular process time, the component is then cooled to room temperature in a controlled manner. It is advantageously possible to use the ADI material in bearing components in which a load distribution requires relatively high yield points and tensile strengths with simultaneously high ductility. This makes it possible to build lighter components with the same structural strength.

A further advantage of ADI is also that ADI can also be inductively hardened. It is possible here for the main structure of the bearing component to include ADI, and for the main structure of the outer layer in the region of the raceway to include hardened ADI. In other words, a bearing component consisting of spheroidal graphite cast iron can be transformed locally to ADI and/or a boundary layer of the spheroidal graphite cast iron can additionally be inductively hardened. In particular, ADI is much easier and less expensive to produce than forged steel.

In a further aspect, a process for producing a bearing component is provided. The present bearing component includes a main body that forms the bearing component, where the main body has at least one raceway designed such that at least one rolling body can roll thereon. The process comprises the following steps:
casting the main body of the bearing component from cast iron,
processing the main body in order to provide the bearing component with defined dimensions,
inductively hardening the raceway,
annealing the bearing component, and
processing the hardened raceway.

The cast iron is preferably a spheroidal graphite cast iron. As already detailed above, cast iron comprising spherical graphite or else spheroidal graphite cast iron is an iron-carbon casting material, where the carbon is in the form of spheroidal graphite particles. Spheroidal graphite cast iron can advantageously have steel-like mechanical properties.

In addition, the processing of the hardened raceway may comprise, for example, turning, grinding, honing, polishing or any appropriate machining or forming process.

In a further preferred embodiment, the processing of the bearing component, in order to provide the bearing component with defined dimensions, is preceded by heat treatment of the main body in order to transform the cast iron at least partly to ADI. As already stated, ADI has relatively high yield points and tensile strengths coupled with simultaneously high ductility, and simultaneously offers the advantages of a cast material with regard to shaping.

The basis used for ADI is spheroidal graphite cast iron, which is subjected to a specific heat treatment referred to as bainitization or ausferritization. In this treatment, the component is first austenitized, then quenched to a defined or specified temperature, in order to remain isothermally at that temperature for a prolonged period in the continuation of the process (isothermal transformation). After a particular process time, the component is then cooled to room temperature in a controlled manner. It is advantageously possible to use the ADI material in bearing components in which a load distribution requires relatively high yield points and tensile strengths with simultaneously high ductility. This freedom offered by the casting process enables the building or producing of lighter components with the same structural strength.

The heat treatment used to form the austenitic-ferritic spheroidal graphite cast iron is preferably affected by inductive heating. Inductive heating makes it possible also to treat the component merely partially with heat, such that even complex geometries, for example in the case of significantly varying wall thicknesses, can be treated without intrinsic stress problems and/or uncertainties as to whether an ADI microstructure is truly formed throughout the component. Exclusive treatment of the component regions of relevance from the functional layer ensures that the desired material state exists in these regions. In addition, because both the austenitization and the isothermal transformation are performed by induction, a bearing component made of ADI can be produced in a much less costly and environmentally benign or friendly manner. In particular, a bearing component consisting of spheroidal graphite cast iron can be transformed locally to ADI and/or a boundary layer of the spheroidal graphite cast iron can additionally be inductively hardened.

Furthermore, in an additional process step, the heat treatment to form ADI may be followed by quenching of the bearing component, keeping the bearing component at a defined transformation temperature during the quenching. The isothermal transformation temperature can influence the resultant microstructure and hence the mechanical properties of the castings or components. The lower the temperature, the higher the resulting hardness and strength of the material, and the lower the residual austenite content. The defined or specified transformation temperature is preferably less than 300° C.

Further advantages and advantageous embodiments are specified in the description, the drawings and the claims. In particular the combinations of the features specified in the description and in the drawings are purely illustrative here, and therefore the features can also be present individually or in other combinations.

### BRIEF DESCRIPTION OF THE SEVERAL VIEWS OF THE DRAWINGS

The invention will be described in detail hereinafter with reference to working examples shown in the drawings. The working examples and the combinations shown in the working examples are purely illustrative and are not intended to restrict the scope of protection of the invention. The latter is defined solely by the appended claims.

The figures show:

FIG. 1 a schematic side view of a bearing component according to a first embodiment;

FIG. 2 a schematic side view of a bearing component according to a second embodiment;

FIG. 3 a schematic side view of a portion of a bearing component according to a third embodiment; and

FIG. 4 a schematic diagram of a process for producing a bearing component according to a fourth embodiment.

### DETAILED DESCRIPTION OF THE INVENTION

Identical or functionally identical elements are identified by the same reference numerals hereinafter.

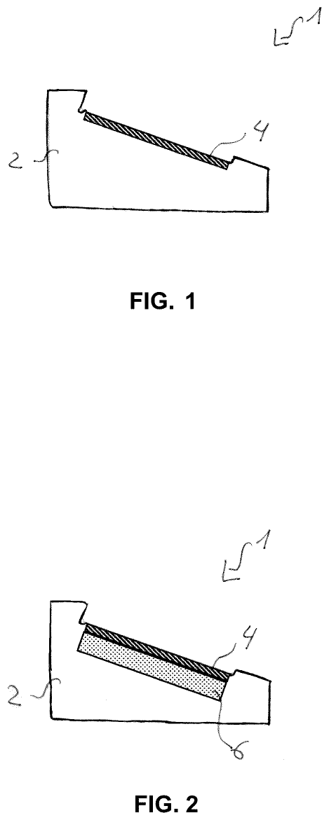

FIG. 1 shows a bearing component 1 according to a first embodiment. The bearing component 1 shown in FIG. 1 is a bearing ring for a roller bearing. The bearing component 1 comprises a main body 2 having at least one raceway 4 designed such that at least one rolling body (not shown) can roll thereon; in other words, the raceway 4 is configured to support at least one and preferably a plurality of rolling elements. The at least one rolling body may, for example, be a ball, a cylinder roller, a cone roller, a pendulum roller, a needle roller or the like.

The bearing component 1 is manufactured from cast iron. For example, the bearing component 1 may have been manufactured from cast iron having a carbon content of greater than 2% (>2%). The bearing component 1 has preferably been produced from spheroidal graphite cast iron, where the carbon in spheroidal graphite cast iron is in the form of spheroidal graphite particles. Moreover, the raceway 4 is an inductively hardened raceway. This means that the raceway 4 is formed directly on the bearing component 1.

In the case of inductive hardening or inductive boundary layer hardening, there is only partial hardening in the outer layers. During inductive surface hardening, new material properties can arise in the hardened regions through austenitization due to the transformation of microstructure. In the case of inductive hardening, the hardened surface can become wear-resistant and/or hard, while the ductility of the starting or initial material, in this case the cast iron, is conserved in the interior of the bearing component 1. In the case of inductive hardening, the components may be subjected to a varying magnetic field for a very short period of time, which results in heating of the bearing component 1 at its surface. The extent to which the heating penetrates into the bearing component 1 may be especially dependent on the frequency of the magnetic field. The higher the frequency of the magnetic field, the smaller or lesser the depth of the fully heated layer. The inductive hardening is preferably followed by quenching, for example, by water.

FIG. 2 shows a bearing component 1 according to a second embodiment. The bearing component 1 shown in FIG. 2 differs from the bearing component 1 shown in FIG. 1 in that the main body 2 of the bearing component has been manufactured from spheroidal graphite cast iron that has been transformed to ADI (Austempered Ductile Iron) at least within a region 6 beneath the raceway 4. ADI is an austenitic-ferritic spheroidal graphite cast iron and is described, for example, in DIN EN 1564:2012-01. ADI may be used as alternative to cast steel and also forged steel in components that are subject to high stress, and, for a spheroidal graphite cast iron, has relatively high yield points and tensile strength with simultaneously high ductility, and at the same time offers the advantages of a casting material with regard to shaping or forming.

In order to form ADI, spheroidal graphite cast iron is subjected to a specific heat treatment which is referred to as bainitization or ausferritization. In this treatment, the microstructure of the bearing component 1 is first austenitized, then quenched to a defined or specified temperature, in order to remain isothermally at that temperature for a prolonged period, i.e., the duration of the process. After a particular or specified process time, the bearing component 1 is then cooled to room temperature in a controlled manner. After the ADI has been formed in the region 6 of the bearing component 1, the raceway 4 is additionally inductively hardened.

In FIG. 2, the ADI is formed in the region of the raceway 4. It is of course also possible that the ADI is additionally or alternatively formed in other regions of the bearing component 1. ADI can preferably be used in regions in which the bearing component 1 is subject to exceptional stresses.

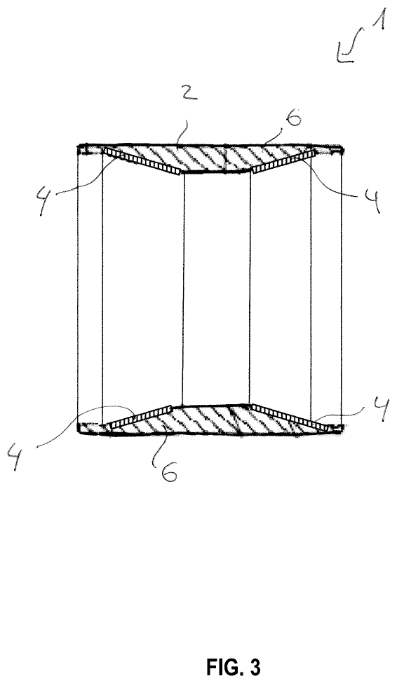

FIG. 3 shows a part of a bearing component 1 according to a third embodiment. The bearing component 1 shown in FIG. 3 differs from the bearing component 1 shown in FIG. 2 in that the bearing component 1 is a gear hub. The bearing component 1 shown in FIG. 3 has a main body 2 formed from spheroidal graphite cast iron that has been transformed at least partly to ADI.

In addition, the bearing component 1 depicted in FIG. 3 in the form of a gear hub has two raceways 4 that have preferably been inductively hardened. This means that the bearing component 1 from FIG. 3 in the form of a gear hub can be used directly as outer ring for a two-row bearing unit of a wheel bearing. This has the advantage that it is possible to dispense with indentation or insertion of separate bearing rings into the gear hub, which reduces a material thickness that would be necessary due to the required overlap tolerances in the case of indented or inserted bearing rings. A further advantage is that there is no occurrence of a phenomenon known as creeping, in which an indented bearing ring rotates relative to the gear hub, since the raceway 4 is integrated in the bearing component 1.

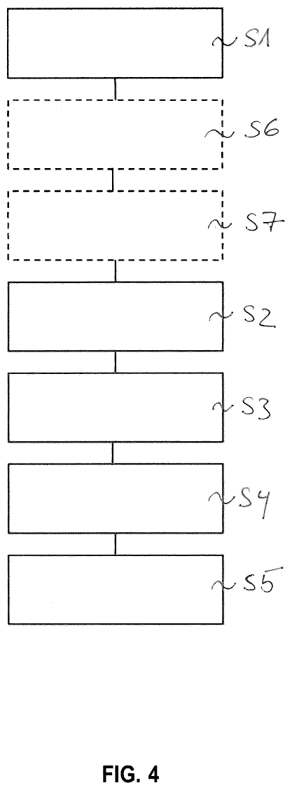

FIG. 4 shows a schematic diagram of a process for producing the bearing component 1. In a first step S1, the main body 2 is cast from cast iron, especially from spheroidal graphite cast iron. Subsequently, in a next or second step S2, the main body 2 is processed in order to provide the bearing component 1 with defined dimensions, e.g., by appropriate machining, etc.

Thereafter, in a third step S3, the at least one raceway 4 is inductively hardened. In order to complete the bearing component 1, the bearing component 1 is then annealed in a fourth step S4. Subsequently, in a fifth step S5, the final processing of the hardened raceway takes place. The final processing may comprise, for example, turning, grinding, honing, polishing or the similar machining processes.

If the bearing component 1 is made of spheroidal graphite cast iron, a sixth step S6 may optionally be provided executed prior to the processing of the bearing component in step S2, a heat treatment of the main body 2, in order to at least partly transform the spheroidal graphite cast iron to ADI.

The heat treatment to form ADI is preferably affected by inductive heating. In particular, inductive heating makes it possible also to treat the bearing component 1 merely partially with heat, such that even complex geometries, for example in the case of significantly varying wall thicknesses, can be treated without intrinsic stress problems and/or uncertainties as to whether an ADI microstructure is truly formed throughout the component. Exclusive treatment of the component regions of relevance from the functional layer ensures that the desired material state exists in these regions.

Furthermore, in a further optional process seventh step S7, the heat treatment in the sixth step S6 to form ADI may be followed by quenching of the bearing component 1, keeping or maintaining the bearing component 1 at a defined or specified transformation temperature during the quenching. The isothermal transformation temperature can influence the resultant microstructure and hence the mechanical properties of the castings or component. The lower the temperature, the higher the resulting hardness and strength of the material, and the lower the residual austenite content. The defined or specified transformation temperature is preferably less than 300° C.

In summary, it is possible to provide a bearing component 1 that requires less weight and/or material compared to known bearing components. By virtue of the integrated, inductively hardened raceway(s) 4, it is possible to reduce a material thickness needed due to the necessary overlap tolerances in the case of indented or inserted bearing rings, since each raceway 4 is formed directly on the bearing component. A further advantage is that a phenomenon referred to as creeping, in which an indented component rotates relative to the other component and which can occur in the case of a press fit does not occur in the case of the present bearing ring 1, since the raceway 4 is integrated in or provided by the component 1. It is advantageously possible to transform the microstructure of the bearing component 1 to ADI at least partly in the regions of the bearing component 1 in which a load distribution requires relatively high yield points and tensile strengths with simultaneously high ductility. This freedom offered by the casting process enables building of lighter components with the same structural strength.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

### LIST OF REFERENCE SIGNS

1 bearing component
2 main body
4 raceway
6 ADI region

We claim:

1. A bearing component for a roller bearing, the bearing component comprising:
a main body forming the bearing component and having at least one raceway configured to support at least one rolling body, the main body being made of cast iron and the at least one raceway being inductively hardened.

2. The bearing component according to claim 1, wherein the cast iron is a spheroidal graphite cast iron.

3. The bearing component according to claim 1, wherein the main body is at least partly formed of austenitic-ferritic spheroidal graphite cast iron.

4. The bearing component according to claim 3, wherein at least a region of the main body including the at least one raceway is made from austenitic-ferritic spheroidal graphite cast iron.

5. The bearing component according to claim 1, wherein the bearing component is a gear hub and/or a bearing ring.

6. A process for producing a bearing component, the bearing component including a main body and the main body having at least one raceway designed to support at least one rolling body, the process comprising the steps of:
casting the main body of the bearing component from cast iron;
processing the main body to provide defined dimensions of the bearing component including at least one raceway;
inductively hardening the at least one raceway;
annealing the bearing component; and
processing the hardened raceway.

7. The process according to claim 6, wherein the cast iron is a spheroidal graphite cast iron.

8. The process according to claim 7, further comprising a step of heat treating the main body in order to transform the cast iron at least partly to austenitic-ferritic spheroidal graphite cast iron prior to the step of processing of the main body to provide the bearing component with the predefined dimensions.

9. The process according to claim 8, wherein the heat treatment to form the austenitic-ferritic spheroidal graphite cast iron is affected by inductive heating.

10. The process according to claim 8, further comprising a step of quenching the main body after the step of heat treating the main body to form the austenitic-ferritic spheroidal graphite cast iron, the main body being maintained at a specified transformation temperature during the quenching.

11. The process according to claim 10, wherein the specified transformation temperature is less than 300° C.
